(19) United States
(12) Patent Application Publication
(10) Pub. No.: US 2010/0318916 A1
(43) Pub. Date: Dec. 16, 2010

(54) SYSTEM AND METHOD FOR GENERATING MULTIMEDIA PRESENTATIONS

(76) Inventor: David Wilkins, Quebec (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 12/813,785

(22) Filed: Jun. 11, 2010

Related U.S. Application Data
(60) Provisional application No. 61/186,218, filed on Jun. 11, 2009.

(51) Int. Cl. G06F 3/01

(52) U.S. Cl. 715/730

(57) ABSTRACT

A system and method are provided for generating broadcast-quality multimedia productions using slide-show presentations without requiring a complex set up or configuration process, or the need for specialized technicians. The system enables pre-loaded, preconfigured elements to be rendered with a common presentation file such as that created in PowerPoint®. A smart projection module is provided as an interface between the presentation itself and various inputs used to enhance the presentation, the effort associated with rendering a consistent, broadcast-quality production is minimized or even eliminated.

This application claims priority from U.S. Provisional Application No. 61/186,218 filed on Jun. 11, 2009, the contents of which are incorporated herein by reference.

### TECHNICAL FIELD

The following relates to systems and methods for generating multimedia presentations.

### BACKGROUND

The use of slide-show presentations has become an important tool in boardrooms, conference rooms and many other settings such as live webcasts, teleconferencing and tradeshows. Typically, a software program such as Microsoft PowerPoint® is used to generate a series of slides, each slide containing the content and multimedia components chosen by the presenter. The slides can be created using a slide layout template and various formatting is possible as well as the incorporation of animations, audio and graphics.

Often, in particular during conferences, tradeshows, or boardroom meetings with multiple presenters, individual presentations need to be loaded for each presenter. It can be difficult to maintain a consistent look and feel between presentations and switching between presentations or between presentations and other information that is to be displayed can be cumbersome and sometimes appears to be of unprofessional quality.

Typically, when multiple outputs are required during a presentation, e.g. a slide-show presentation and a camera feed of the presenter, separate screens are used and the coordination of such outputs can require skilled audio-visual (A/V) technicians. Moreover, the set up and configuration of the equipment can be time consuming and can lead to unexpected or undesirable delays or errors in the overall production.

It is therefore an object of the following to address the above-noted disadvantages.

### SUMMARY

It has been found that by providing a smart projection module as an interface between the presentation itself and various inputs used to enhance the presentation, the effort associated with rendering a consistent, broadcast-quality production is minimized or even eliminated. As will be described below, a platform is provided which turns any existing presentation such as a PowerPoint® slideshow into such a multimedia production while only requiring the user to connect their computer (e.g. laptop) to the platform in the same way one would normally connect to a projector for directly outputting the presentation to the projector screen.

In one aspect, there is provided a method for generating a presentation output comprising providing a smart projection module as an interface between a presentation output and one or more additional inputs to be added to the presentation output; and providing a user input mechanism to control the presentation output to utilize a plurality of template configurations. A system is also provided for performing the method.

### BRIEF DESCRIPTION OF THE DRAWINGS

Embodiments will now be described by way of example only with reference to the appended drawings wherein:

FIG. 1 is a schematic diagram of a smart projection system.

FIG. 2 is a pictorial diagram of an embodiment of the smart projection system shown in FIG. 1.

FIG. 3(a) is a schematic diagram illustrating a smart projection module box.

FIG. 3(b) is a schematic diagram illustrating a smart projector.

FIG. 4 is a schematic block diagram of an exemplary configuration for the broadcast rendering engine shown in FIGS. 3(a) and 3(b).

FIG. 5 is a schematic diagram illustrating example configuration settings, example keypad settings, and an example configuration interface.

FIG. 6 is a flow diagram illustrating the incorporation of a presentation and various inputs into a template to generate an exemplary projector output displayed on a projector screen.

FIG. 7 is a schematic block diagram of a smart object.

FIG. 8 is a schematic block diagram of an intelligent template.

FIGS. 9 to 14 are screen shots showing various configurations for the presentation output.

FIG. 15 is a flow chart illustrating an exemplary set of computer executable operations for generating a multimedia presentation output by incorporating a presentation file into a template.

FIG. 16(a) is a system diagram of an example configuration for enabling one or more remote participants to view and participate in a presentation in a physical boardroom environment.

FIG. 16(b) is system diagram of an example configuration for enabling one or more remote participants to view and participate in a presentation in a virtual boardroom environment.

FIG. 17 is a system diagram of an example configuration for a multiple-channel presentation system.

FIG. 18 is an example user interface for tuning into selected ones of the multiple presentation channels of FIG. 17.

### DETAILED DESCRIPTION OF THE DRAWINGS

It has been recognized that a need and desire exists for generating broadcast-quality multimedia productions using slide-show presentations without requiring a complex set up or configuration process, or the need for specialized technicians. There is a need to enable pre-loaded, preconfigured elements to be rendered with a common presentation file such as that created in PowerPoint®. In this way, a user can concentrate on creating the content necessary for the presentation without the difficulties associated with formatting, branding, or quality of production.

It has been found that by providing a smart projection module as an interface between the presentation itself and various inputs used to enhance the presentation, the effort associated with rendering a consistent, broadcast-quality production is minimized or even eliminated. As will be described below, a platform is provided which turns any existing presentation such as a PowerPoint® slideshow into such a multimedia production while only requiring the user to connect their computer (e.g. laptop) to the platform in the same way one would normally connect to a projector for directly outputting the presentation to the projector screen.

The platform can be integrated into a “smart” projector or can be provided as a separate box interposed between computer and projector. The platform provides the necessary interfaces to enable templates to be stored and configuration settings to be tailored to a user or the environment in which the projector is used. For example, the platform can be installed permanently in a boardroom or at a conference centre enabling pre-loaded content such as graphics, logos and other branding to be seamlessly included in any presentation in that location. On-the-fly changes can be conveniently triggered using a simple keypad or touch-screen with pre-programmed functions or can utilize a web or network based connection to a graphical user interface (GUI) to upload new content, templates or simply make changes according to last minute updates, either locally or remotely.

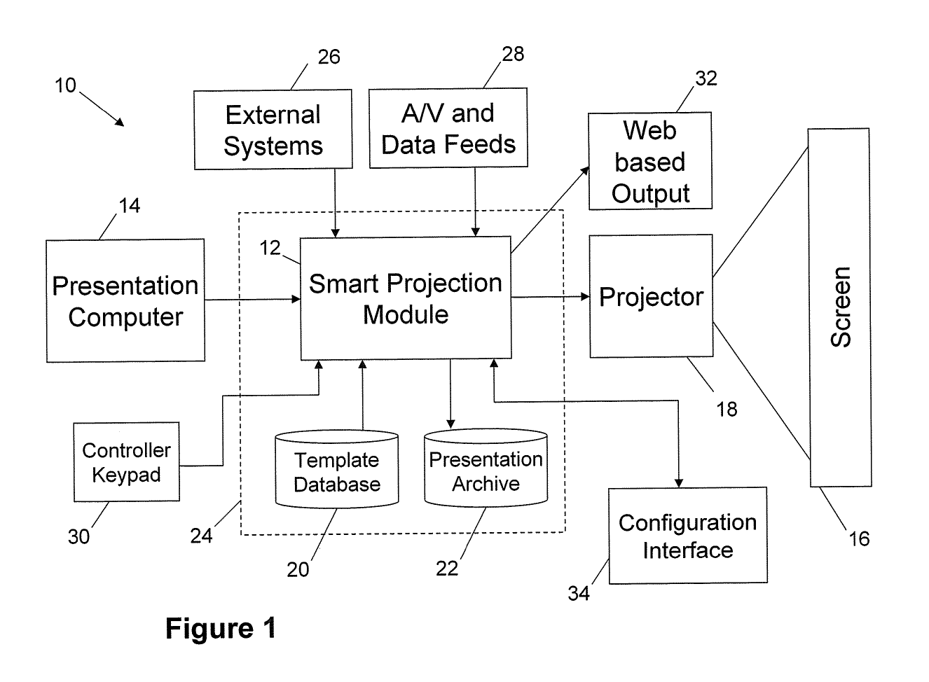

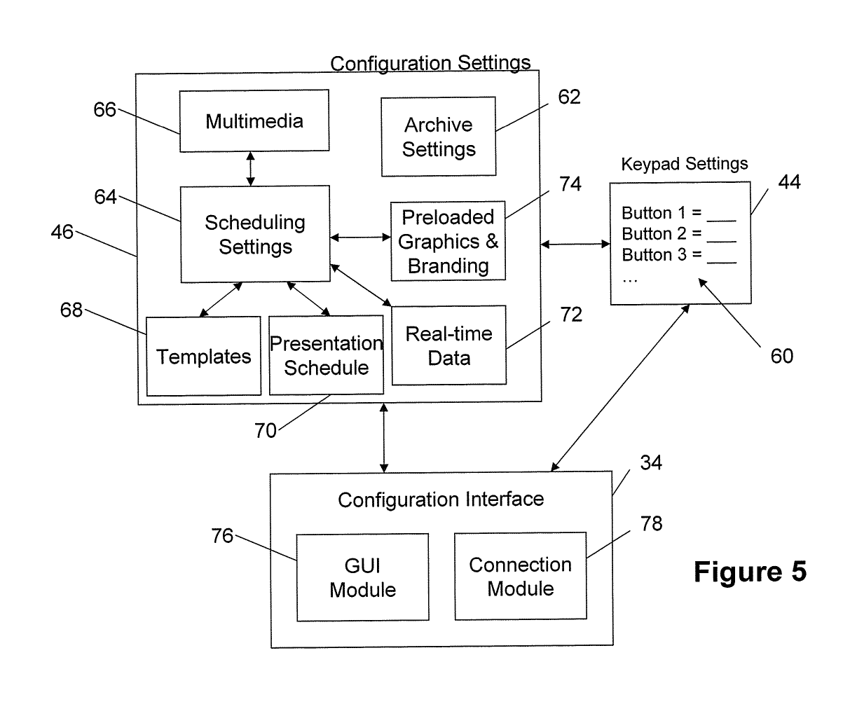

Turning now to FIG. 1, a smart projection system is generally denoted by numeral 10 and may be configured in numerous ways, one of which is exemplified in FIG. 1. The system 10 in this example comprises a smart projection module 12 which provides a tool for generating a broadcast-quality production as discussed above. The smart projection module 12 obtains a presentation from a presentation computer 14 (e.g. laptop used in a boardroom) and generates an output that is projected onto a screen 16 using a projector 18. The smart projection module 12 includes or otherwise has access to a template database 20 which contains one or more templates 21 (see also FIG. 5) defining the arrangement of the various elements in the production. The smart projection module 12 also includes or otherwise has access to a presentation archive 22 to enable it to capture presentations and save to a file for archiving purposes.

In the example shown in FIG. 1, the dashed line surrounding the smart projection module 12, template database 20, and presentation archive 22 indicates that these components may be included together, either in a separate box or housing, hereinafter a “platform 24”. These components may also be embedded in another device such as the projector 18 or presentation computer 14 either as software, hardware or a combination of both as will be exemplified below. It will also be appreciated that the smart projection module 12, template database 20, and presentation archive 22 may instead be provided as separate, detachable components in any suitable configuration. For example, the template database 20 and/or presentation archive 22 can be stored on one or more removable memory devices such as USB drives, or can be stored and accessed remotely over a network connection.

The smart projection module 12 comprises various interfaces to obtain various inputs 25 to be incorporated with a presentation 23 according to a template 21 (see also FIG. 5). In the example shown in FIG. 1, one or more interfaces with external systems 26 are provided to enable the smart projection module 12 to be integrated with existing A/V systems, digital signage networks, central scheduling systems, etc. This enables content and data to be shared or reused in such various systems and applications. The smart projector module 12 also provides one or more interfaces with A/V and data feeds 28, for example camera and microphone feeds (for production and/or archiving) and real-time data such as weather or news headlines, advertising, etc. In addition to controlling the output according to templates 21, components of the templates 21 and/or switching between templates 21 and/or triggering other presentation elements such as animations, can be controlled using a controller keypad 30. The controller keypad 30 enables pre-programmed functions to be triggered by simply pressing a button correlated to a specific function for on-the-fly changes or simply to control the timing of the presentation. For example, the user can use a pair of buttons to advance or retrace through slideshow slides, switch between templates to move to a new presenter, swap camera feds or other outputs with an agenda list, or any other control commands they wish to incorporate. It can be appreciated that the keypad 30 can be a button-based input mechanism, a touch-screen based input mechanism, or any other suitable input mechanism (e.g. voice controlled, foot pedal controlled, etc.).

As discussed above, the smart projection module 12 generates a broadcast-quality production that can be fed to the projector 18, which in turn casts the output on the projector screen 16. The smart projection module 12 can also archive the production while it is being rendered. In addition to outputting the production locally, i.e. physically, the smart projection module 12 can also be configured to encode the production and stream the presentation as a web-based output 32. This allows the same broadcast-quality production to be distributed to other locations to enable more dynamic presentations across various formats. Similarly, the web-based output 32 can be used for webcasts or during teleconferences in addition to or instead of a live presentation using a projector.

In order to render a production that incorporates the various inputs 25 discussed above in conjunction with the presentation 23 itself, the smart projection module 12 is typically configurable to enable templates 21, graphics, branding, and access to live A/V and data feeds 28 to be preset. In this way, the user can generate a basic presentation and have this rendered in a consistent and professional manner, each time. To configure the smart projection module 12 in this way, a configuration interface 34 can be provided. The configuration interface 34 may be implemented in many ways, as will be explained further below. For example, the configuration interface may be a web-based GUI either local or remote, incorporated into a third party A/V system, incorporated into the presentation computer, or even provided directly on the platform 24 or projector 18. As such, it can be appreciated that the configuration interface 34 shown in FIG. 1 is shown as a separate module for illustrative purposes only and can be suitably altered or incorporated with other modules suitable to the particular application.

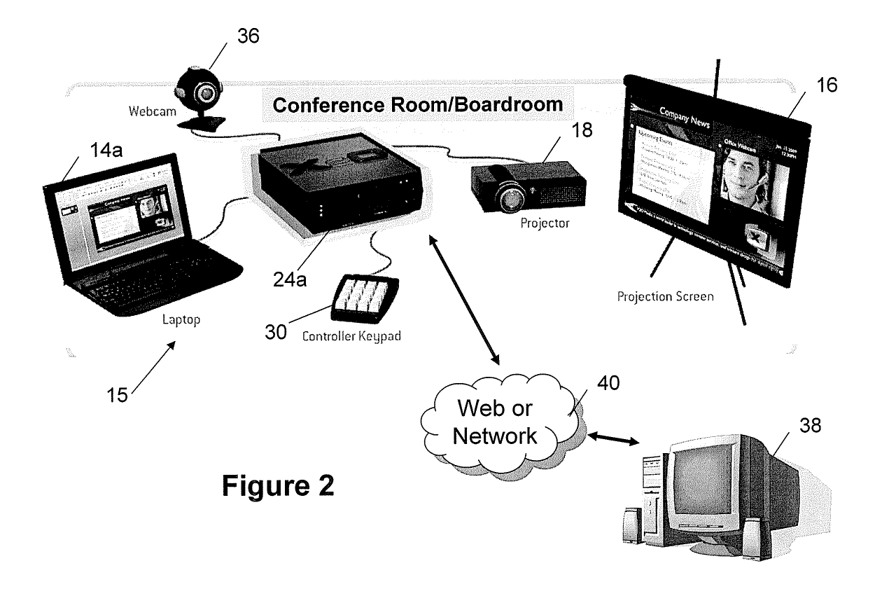

Turning now to FIG. 2, one example of the system 10 is provided in a boardroom environment 15. In this example, the platform 24a is implemented as an embedded system or dedicated hardware “box” which acts as an intermediary between the various other components shown. A laptop 14a containing the presentation 23 can be plugged into the platform 24a along with a webcam 36 or other video equipment to provide a video feed. The video feed and the presentation 23 can then be overlaid with preloaded graphics, logos, etc. according to a template 21, and output as an enhanced, broadcast-quality to a projector 18 for display on a projection screen 16. An example of the controller keypad 30 is also shown and in this example is a relatively small keypad with each button being correlated to a particular function. The keypad 30 can thus generate commands for the platform 24a for causing on-the-fly changes or to otherwise control the presentation 23. Also shown in FIG. 2 is a web or network 40 to which the platform 24a can be connected to provide the capability of making configuration or settings changes (or performing some or all of the controller keypad 30 functions) from a separate computer station 38, e.g. part of a third party system or from a remote location.

It can be appreciated that the web or network connection enables the platform 24a to be pre-loaded, pre-configured or even controlled on-the-fly at any time. For example, a user may prepare for a presentation by remotely setting up the platform 24a located in another part of the office or in another building and then simply bring the presentation along to generate the presentation output. It can also be appreciated that the laptop 14a and computer station 38 can also be the same device used in different locations. For example, the laptop 14a could be used to first configure the platform 24a remotely and then be used later to load the presentation 23. Also, the presentation 23 can also be loaded remotely such that the laptop 14a is not even needed in the physical location of the projector 18 and platform 24a. Similarly, the platform 24a can be networked with more than one projector 18, e.g. for multiple boardrooms or can be embedded in the projector 18. Accordingly, it will be appreciated that the configuration shown in FIG. 2 is only one example and may other arrangements are possible within the principles described herein.

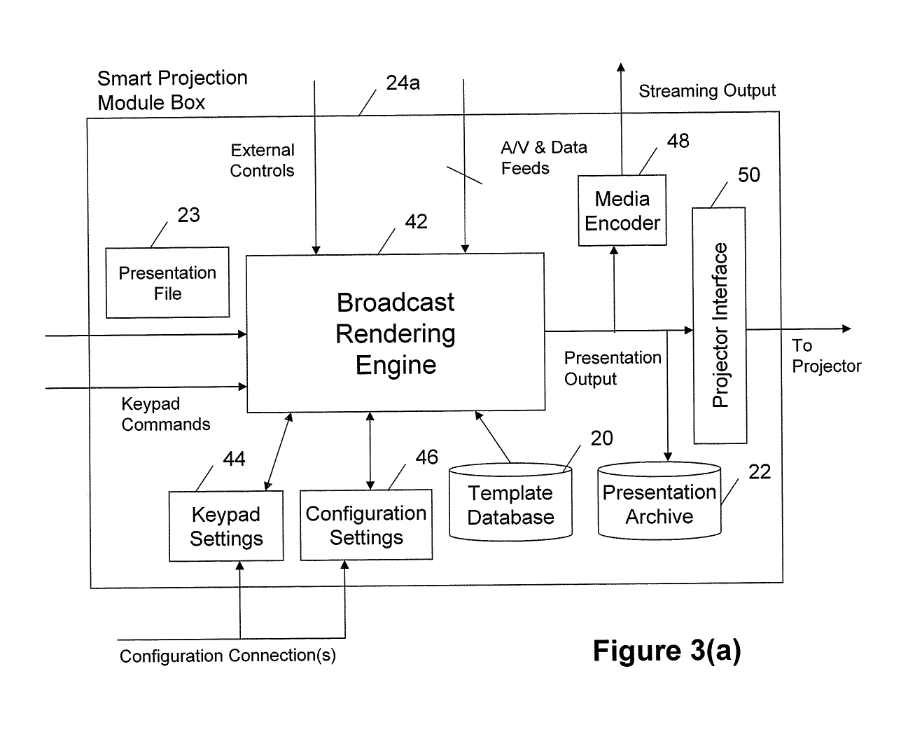

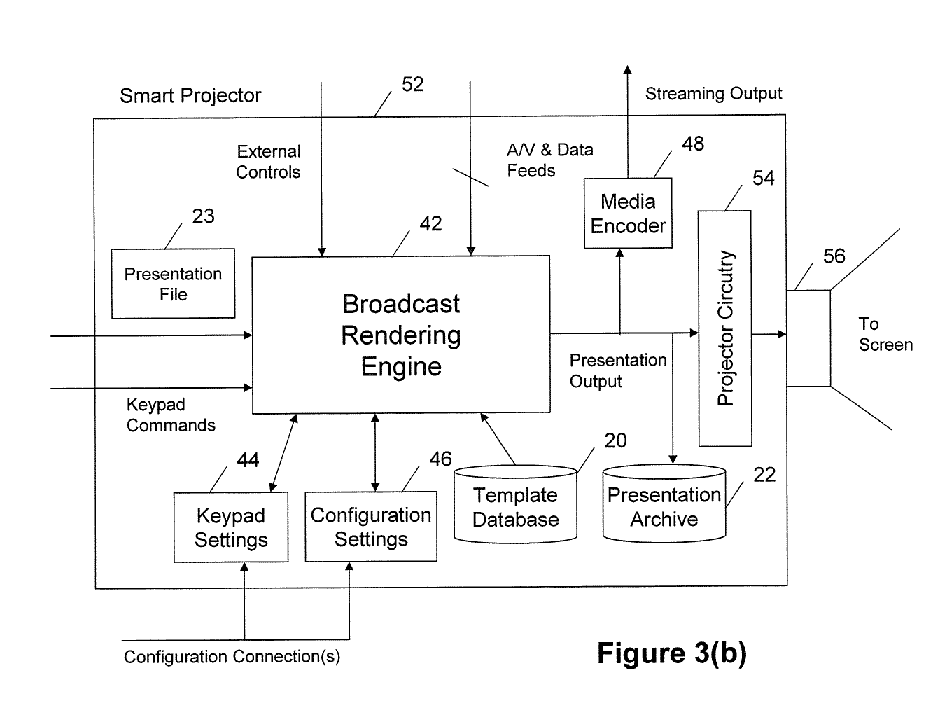

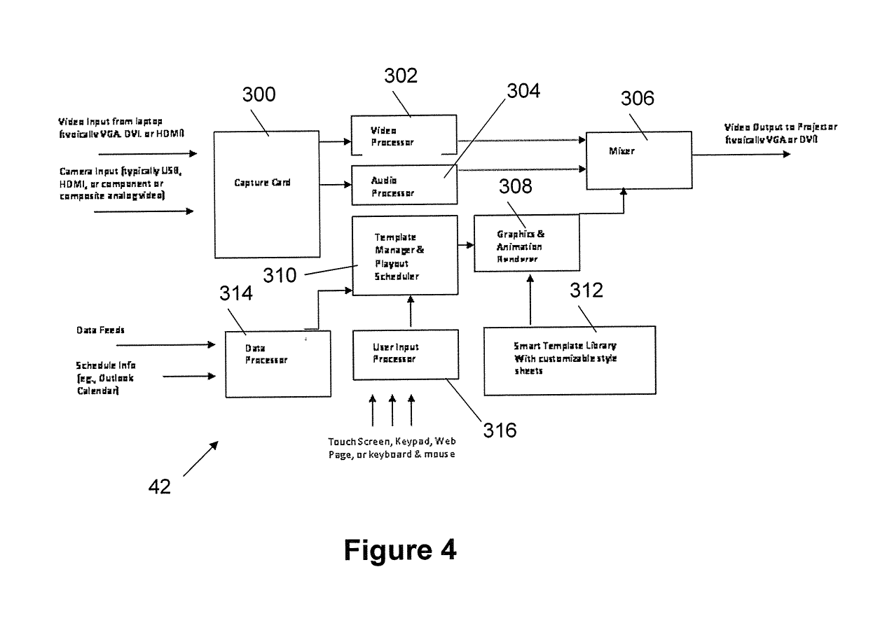

FIG. 3(a) illustrates a schematic diagram of one configuration for the smart projection module 12, namely as a separate embedded platform 24a or box. As can be seen in FIG. 3(a), a broadcast rendering engine 42 is used to overlay the various components on the presentation file 23 in order to generate the presentation output to be fed to the projector 16. A suitable broadcast rendering engine 42 is the Xpresenter™ Player produced by X2O Media, Inc. One example broadcast rendering engine 42 is shown schematically in FIG. 4. In this example, the video input from the laptop as well as the camera input (if used) is input to a capture card 300 which utilizes a video processor 302 and an audio processor 304 to process the multimedia and a mixer 306 combines the outputs of these processors with graphic and animations output by a graphics and animation renderer 308. The graphics and animation renderer combines input from a template manager and playout scheduler 310 and a smart template library 312 with customizable style sheets. The template manager and playout scheduler combines input from a data processor 314 that receives data feeds and schedule information with user input processed by a user input processor 316. The user input processor obtains touch screen, keypad, web page, keyboard and mouse and/or any other user inputs.

The platform 24a in this example stores keypad settings 44 and configuration settings 46, in addition to providing memory allocations for the template database 20 and the presentation archive 22. The keypad settings 44 store the correlations between the physical buttons on the controller keypad 30 and the functions to be triggered by selection of the corresponding button. The configuration settings 46 may comprise any instructions, set-points or values that are referenced by the broadcast rendering engine 42 when generating the presentation output, e.g. scheduling, where to obtain data, etc. The keypad and configuration settings 44, 46 can be uploaded, viewed, modified and deleted through one or more configuration connections, e.g. to the configuration interface 34, presentation computer 14, external system 26, etc. The output from the broadcast rendering engine 42 in this example is fed to a projector interface 50 comprising circuitry required to connect to and communicate with the projector 18. The output may also be fed to the presentation archive 22 such as when production archiving is employed, as well as to a media encoder 48 to stream the presentation output over the web.

FIG. 3(b) illustrates a schematic diagram of another configuration for the smart projection module 12, namely embedded in a projector thus providing a “smart” projector 52. In this example, like elements with respect to FIG. 3(a) are given like numerals. It can be seen in FIG. 3(b) that in this configuration, the components housed by the platform 24a in FIG. 3(a) are instead embedded in the smart projector 52 along with the projector circuitry 54 that would normally be required for operation of a typical projector 18. Therefore, rather than feeding the presentation output to a projector interface 50, the smart projector 52 is itself generating the projector output through a lens 56 that casts the output on the screen 16. It can be appreciated that the integration of the platform 24a into a projector 18 to create a smart projector 52 can be done in any suitable manner, e.g. utilizing existing memory, data buses, etc.; and the configuration shown in FIG. 3(b) is provided for illustrative purposes only. It may also be noted that the components common to FIGS. 3(a) and 3(b) can also be embedded in other devices such as the presentation computer or can be provided remotely and connected over the web or network 40 as desired.

FIG. 5 provides one example showing various configuration settings 46 and keypad settings 44 that may be utilized by the broadcast rendering engine 42 to combine the inputs 25 and presentation 23 and generate the presentation output. In this example, the keypad settings comprise a list of button-function correlations 60 which may be implemented using any applicable computer programming language to effect a function call when a particular button is pressed.

The configuration settings 46 in this example comprise archive settings 62 to indicate when to begin archiving, formats to be used, any size limits on the archiving, where to store the archived files (e.g. if stored remotely or in more than one location) and any other instructions for the broadcast rendering engine 42 or the smart projection module 12 in general to handle archived files. Scheduling settings 64 can also be stored, which relate to the order of operations (if any) and may comprise rules for when certain presentation elements are used. In this example, the various multimedia 66 used can be referenced by the scheduling settings 64 to determine where to obtain camera feeds, audio feeds, etc. as well as the formats needed and when to use them. Similarly, the scheduling settings 64 can reference details of the real-time data 72 such as weather and news feeds to determine when they will be available and when they are to be used. Template settings 68 can also be used by the broadcast rendering engine 42 if different templates 21 are to be used at different times (i.e. as opposed to being controlled by the controller keypad 30). A presentation schedule 70 if available can also be referenced by the scheduling settings to determine when to overlay which elements. Preloaded graphics and branding 74 that have been preloaded can also be referenced in the settings 74, which enables the same system 10 to load different sets of graphics and branding 74 at different times and/or according to different schedules. It can be appreciated that the configuration settings 46 can be arranged, stored and referenced using any suitable data structures and the example shown in FIG. 5 is only one example.

FIG. 5 also illustrates a connection between the configuration interface 34 and the configuration and keypad settings 46, 44. The configuration interface 34 can be used to load, view, edit and delete settings, either locally or remotely. In this example, the configuration interface 34 includes a GUI module 76 which provides a user interface to enable interaction with the settings 44, 46; and includes a connection module 78 which may represent and computer executable instructions and/or hardware necessary to enable the configuration interface 34 to access and communicate with the smart projection module 12 and thus have access to the keypad and configuration settings 44, 46.

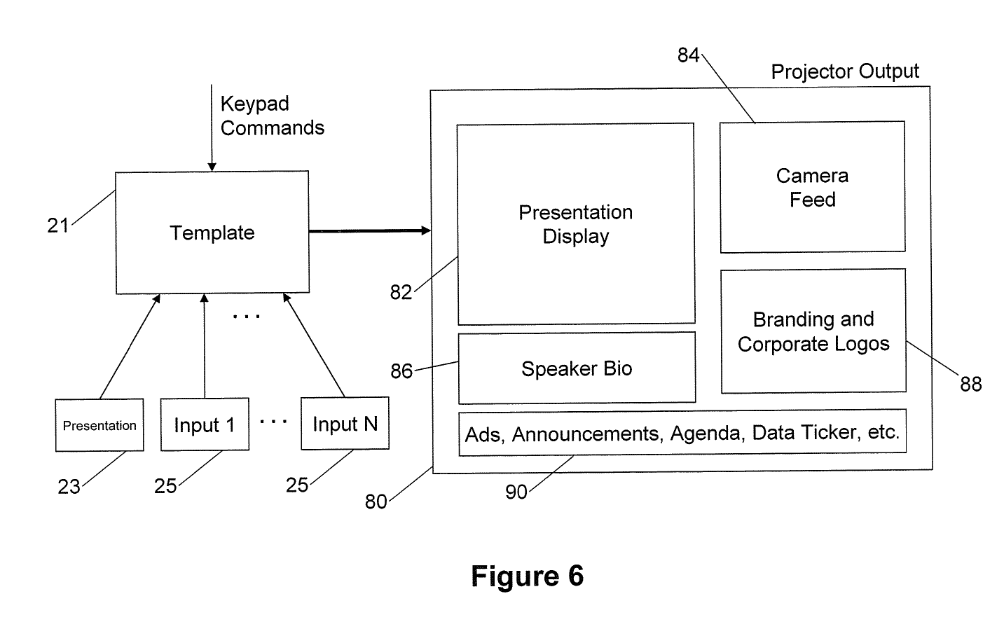

FIG. 6 illustrates an example projector output 80. The template 21 provides a framework and mapping to enable the broadcast rendering engine 42 to overlay the inputs 25 on the presentation 23, while taking into account keypad commands as they are input, to generate a broadcast-quality production, one example of which is shown. In this example, the projector output 80 provides a presentation display 82 to show the presentation content itself. For example, the actual PowerPoint® presentation can be placed in this portion either as is or the content can be extracted from the slides and placed in the presentation display 82. A camera feed 84 is also shown in the example, e.g. to broadcast the presenter as they make the presentation. Various other elements can be overlaid and changed throughout the presentation. For example, the speaker's bio 86 can be displayed under the presentation and this can be updated for each new speaker. Branding and corporate logos 88 can also be displayed, as well as providing a banner type portion 90 which can display ads, announcements, agenda items, data ticker, etc. It can be appreciated that the templates enable the user to enhance the presentation 23 with minimal or no effort over and above creating the presentation 23 itself. Typically, the template database 20 comprises a library of templates 21 to enable the user to pick an appropriate layout for a particular meeting or presentation without having to create a specific format and layout each time.

As shown in FIG. 5, the configuration settings 46 can include timing or scheduling settings 64 to not only overlay presentation elements on presentation content, but also to intelligently control the presentation output. It may be noted that the scheduling settings 64 can reference a clock or can define which cues to look for in order to begin rendering certain elements and/or certain templates 21 (e.g. by receiving a keypad command). In addition to timing and scheduling, the smart projection module 12 can include other forms of intelligent components such as the actual objects used by the templates 21 and the templates 21 themselves.

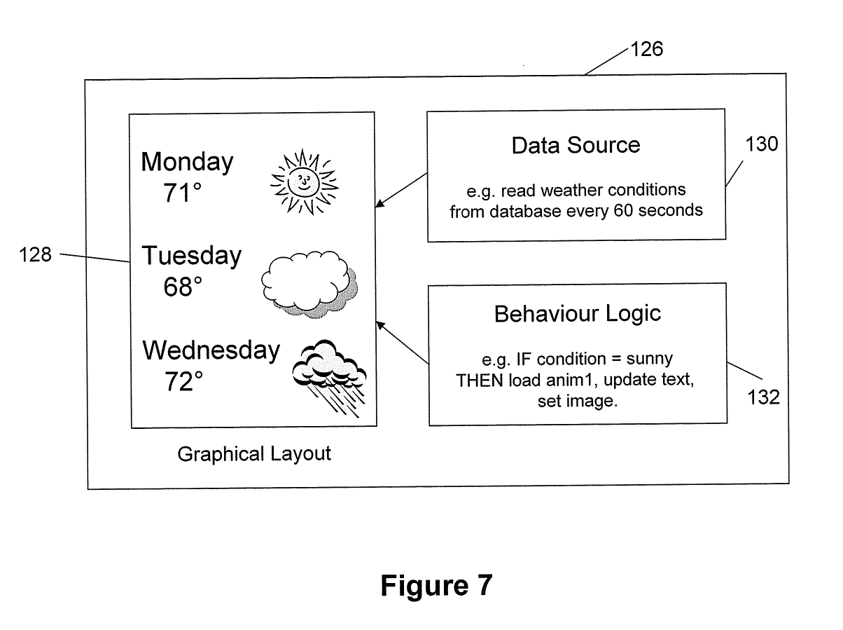

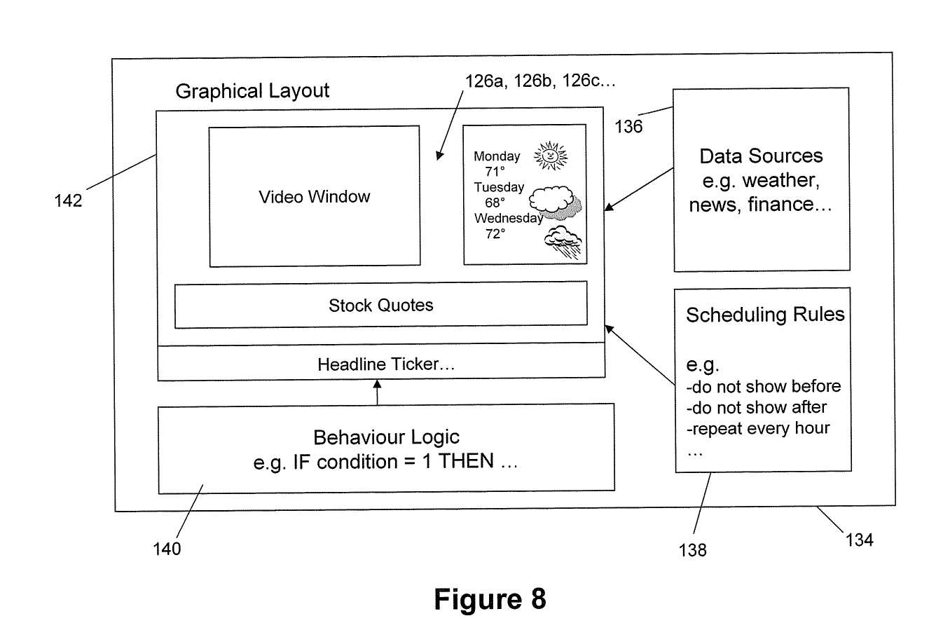

Turning now to FIGS. 7 and 8, the system 10 may utilize smart objects 126 to build intelligent templates 134 to be stored in the template database 20 and used by the broadcast rendering engine 42. In this way, certain properties and parameters defined for a smart object 126 can be inherited by the intelligent templates 134 such that by modifying an object 126, a template 134 can be modified. This allows standard objects 126 and templates 134 to be created that can change for each and every instance and use of the object 126 and template 134 for different applications. The smart objects 126 can be stored in an object library (not shown), e.g. stored in the template database 20.

As can be seen in FIG. 7, the smart object 126 includes a graphic layout 128, data source 130 and behaviour logic 132 to provide conditions for updating content provided by the object 126. As can be seen in FIG. 7, the intelligent template 134 has data sources 136, scheduling rules 138, behaviour logic 140 and a graphic layout 142.

These “smart” components may include a plurality of graphics or video elements, a data layer, and a behaviour layer. These self-contained components can be used to generate a portion of a display, such as a weather or stock ticker, or an entire full-screen video output comprising multiple elements, each with its own set of data sources and individual behaviours. Such portions of the display can be arranged with the presentation display 82, e.g. as shown in FIG. 6 to generate the broadcast-quality production from the original presentation 23.

The use of smart components greatly reduces the need for specialized training on the part of the end user. Whereas in prior systems a user required a certain minimum level of competency as a graphic artist or software developer, the introduction of smart components allows users without any specialized knowledge to quickly and easily create complete applications that combine real-time information sources with dynamic display characteristics for used with the smart projection module 12.

Smart objects 126 form the building blocks needed to create a display component using A/V and/or data feeds 28, and intelligent templates 134 dictate the layout and production logic needed to generate the final video graphics output. Multiple smart objects 126 can be included in an intelligent template 134, and multiple templates 134 can be created from a library of smart objects 126.

Smart objects 126 in this example, may include the following basic characteristics: 1) An object 126 can contain an unlimited number of graphical elements, including text, images, animations, and video; 2) Multiple objects 126 can be used simultaneously to form a composited rich media final output; 3) Each object 126 is entirely self-contained, including all of the graphical and video elements, data sources, and business rules needed to generate a final output; and 4) Objects 126 can be self-configuring, allowing the output to be dynamically modified in response to data triggers, without the need for user intervention. An example of this is a weather graphics that automatically displays a cloud animation when it is cloudy or a sun animation when it is sunny, or a financial graphic that shows a red downward pointing arrow when the stock market is down or a green up arrow when the market is up.

The smart objects 126 are considerably powerful for the end user, since it not only encompasses an object's graphical elements 128, but also the rules or behaviour logic 132 which define how the graphical elements will respond to continuously changing inputs from the data sources 130. Without smart objects 126, this example would require custom software development for each screen layout that is required. With smart objects 126, the rules are defined once, and then reused again and again for any number of screen layouts. Also, the behaviour logic 132 can be used to interrelate multiple objects 126 such that an event relevant to one object 126 triggers a change in another object 126. For example, a smart object 126 comprising weather data can trigger different advertising to be displayed in the banner portion 90. Typical examples of smart objects 126 include: 1) Weather objects showing real-time weather conditions; 2) Sports tickers showing live sports results; 3) Headline tickers that continuously scroll live news information; 4) Video windows that automatically play through a loop of video content; and 5) Alert pop-ups that automatically appear in the event of a fire alarm or weather warning.

Intelligent templates 134 typically include the following characteristics: 1) Layout information defining where each individual object is located on the final output display; 2) Dynamic parameters that can be changed by the user without requiring a re-edit of the template, which can be as simple as a video filename that can be set by the user for a full screen video template, or as complex as a drop list of branding options, each of which completely redefines the entire template layout with a single click; 3) Rules defining how individual objects interact with each other; 4) Scheduling information, defining where and when each template should be displayed; 5) Expiry dates for content, allowing templates to be displayed only within a specified validity period; and 6) Business rules dictating how a template should be reconfigured based on dynamic data inputs, e.g., a single template which, when displayed in a certain location, displays video content applicable to that audience demographic, but when displayed in a different location, displays entirely different video content applicable to a different audience demographic.

Intelligent templates 134 should include everything necessary to generate a complete projector output 80, including graphical elements, video components, multiple data inputs, animations, business rules, and scheduling information 138 to supplement and enhance the presentation 23 and its content.

Using the combination of smart objects 126 and intelligent templates 134, users can build libraries of hundreds or thousands of reusable components, which can be stored in object libraries and the template database 20. These libraries can be shared between smart projection modules 12, e.g. through the configuration interface 34. For many applications, generic default or otherwise existing objects 126 and templates 134 can be used “as is” without modification. For other applications, users can select an existing object 126 or template 134, modify the parameters of that object 126 or template 134, and save it as a new component in the template database 20.

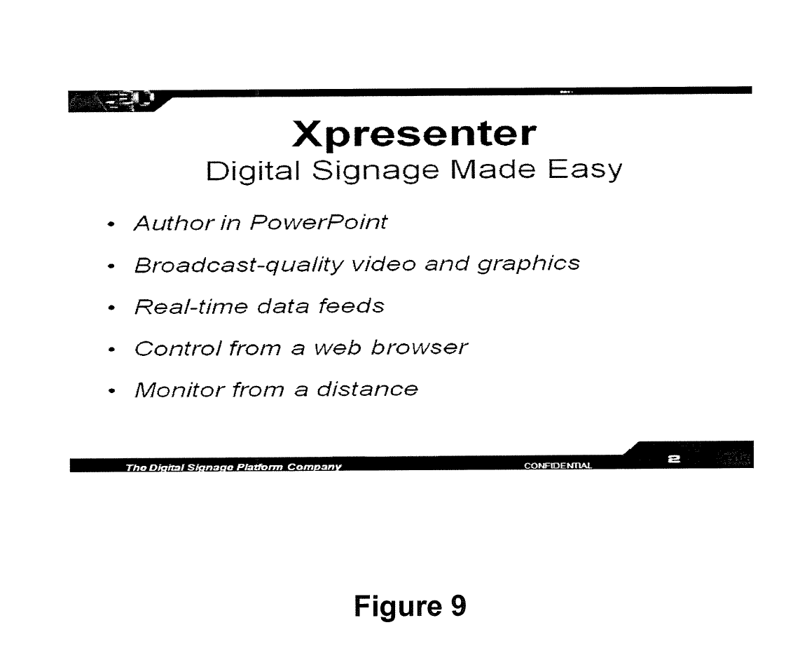

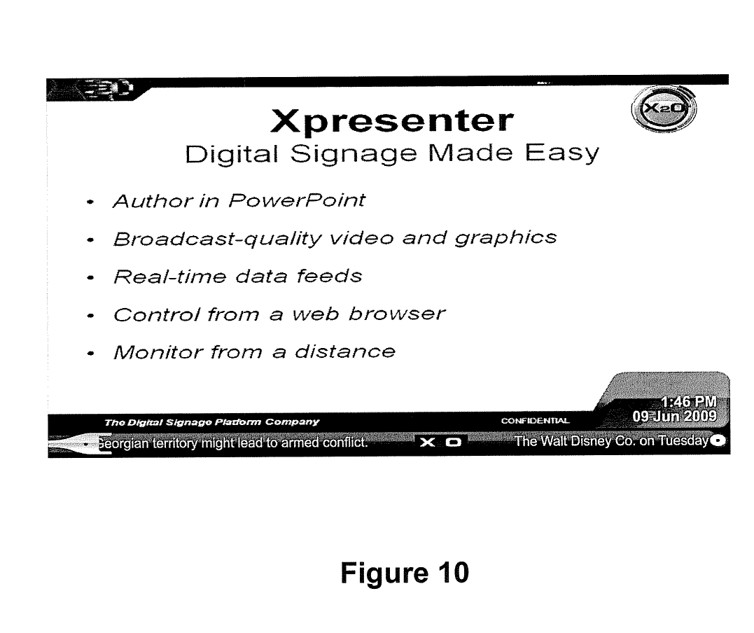

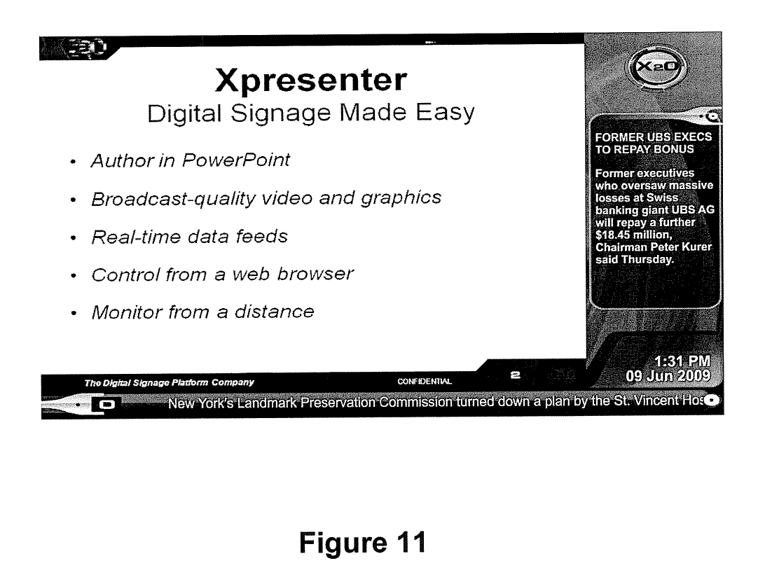

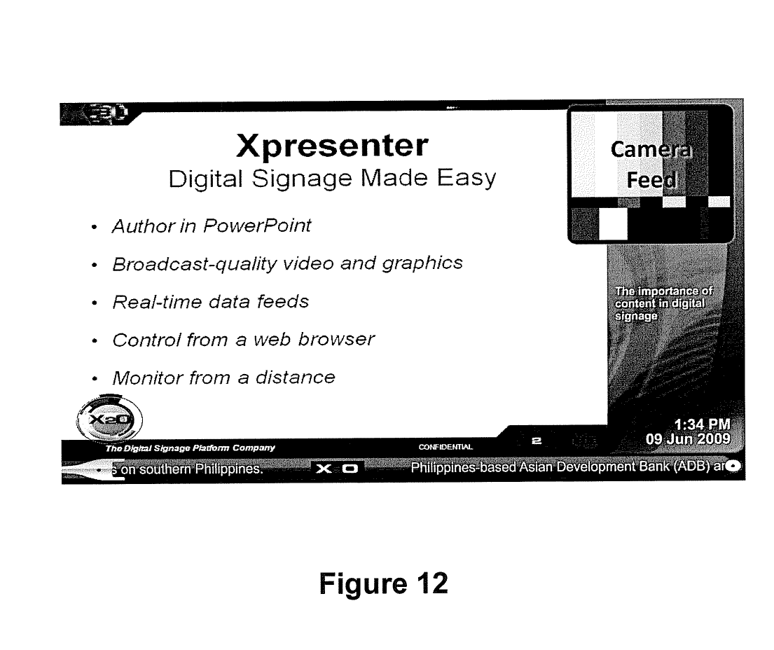

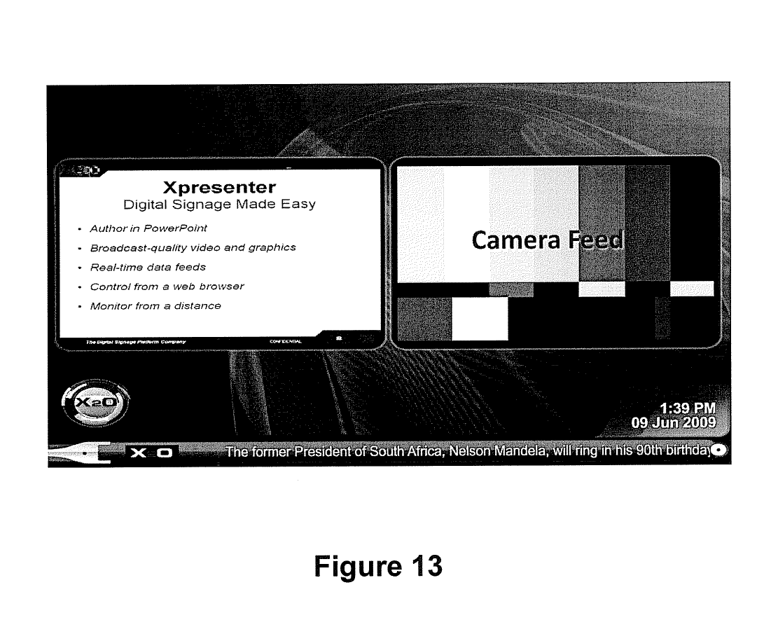

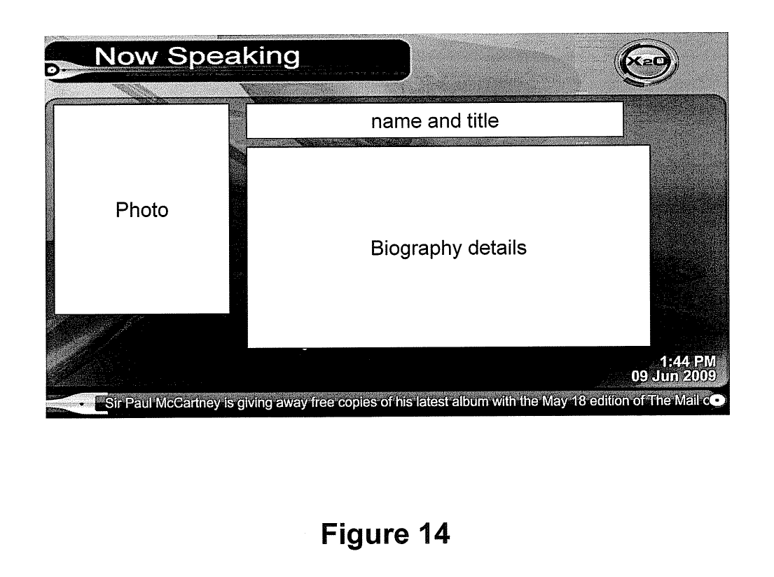

FIGS. 9 to 14 illustrate various screen shots for projector output 80. FIG. 9 shows a direct output from a user's laptop or other computer, projected full screen on the output 80 and thus can be considered a “pass through mode”. FIG. 10 illustrates an overlay comprising a company logo and crawling ticker on the presentation input. FIG. 11 illustrates a resized presentation with a side panel, which can be used to contain speaking notes, company news, etc. FIG. 12 illustrates the addition of a live camera feed, which can be used to show a speaker or may be used for other video input or stream. FIG. 13 illustrates another configuration comprising a camera feed, which may be considered a “two-box” layout. FIG. 14 illustrates a speaker bio layout. This type of configuration can also comprise the meeting agenda, discussion points, or any other kind of full screen content. It may be noted that the speaker bio layout shown in FIG. 14 can be a separate template generated by the system and thus does not need to be included in the main presentation and can be directed to the screen output 80 whenever selected by the user.

All screen layouts in FIGS. 9 to 14 can be called up using the external keypad 30, and it is possible to animate from one layout to another. This enables the user to run his or her own video production using a simple pushbutton keypad, with the resulting output being projected on the screen, saved to a video file, or streamed out across the network.

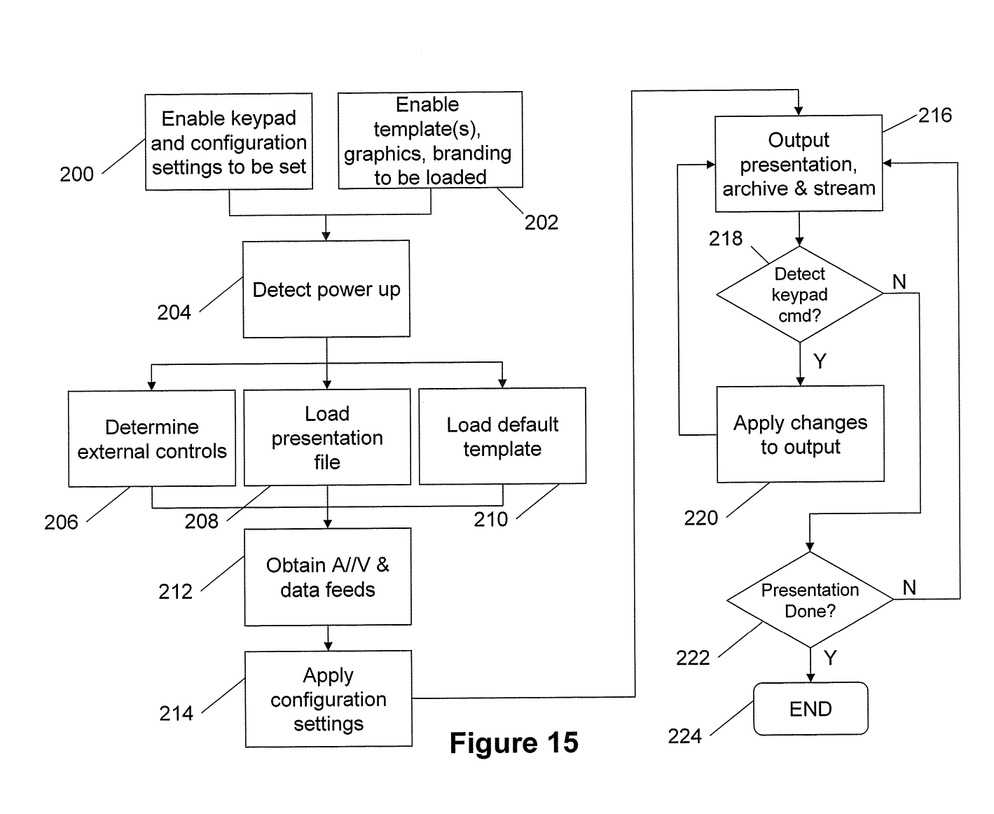

FIG. 15 illustrates a set of computer executable operations that can be performed by the smart projection module 12 to generate a projector output 80. At step 200, the smart projection module 12 enables the keypad and configuration settings 44, 46 to be set. This can be through providing the ability to access the settings 44, 46 through the configuration interface 34 or other suitable communication connection. At step 202, the smart projection module 12 enables the templates, graphics and branding to be loaded and this may also be done through the configuration interface 34. Once steps 200 and 202 have been performed, which can be done in advance of actually using the system 10, the smart projection module 12 may then detect a “power up”, e.g. through a power button or detecting when a laptop 14a or other device is plugged into the platform 24a or smart projector 52. When the system 10 has been set up and powered, the smart projection module 12 determines any external controls that are applicable, e.g. if an external system 26 is detected, at step 206. The presentation file 23 is also loaded at step 208, and the default or otherwise chosen template 21 is loaded from the template database 20 at step 210. The template 21 and/or the configuration settings 46 will indicate if any additional A/V or data feeds 28 are to be used and such feeds 28 are obtained through the appropriate connections at step 212. The configuration settings 46 are also applied where appropriate at step 214, e.g. to initiate a broadcast schedule.

The presentation may then be output to the projector 18, archived to the presentation archive 22, and a web-based output 32 provided at step 216. During the presentation, the smart projection module 12 can monitor the connection to the controller keypad 30 to detect if a keypad command has been generated at step 218. If so, any changes to the presentation and thus the projection output 80 can be applied at step 220 and the presentation, archiving and streaming can continue at step 216.

If there are no keypad commands detected, the smart projection module 12 also determines if the presentation is done at step 222, e.g. according to scheduling settings 64, selection of an off button, movement to a next presentation, etc. If the presentation is not done, the presentation, archiving and streaming continues at step 216. Once the presentation is done, the process ends at step 224.

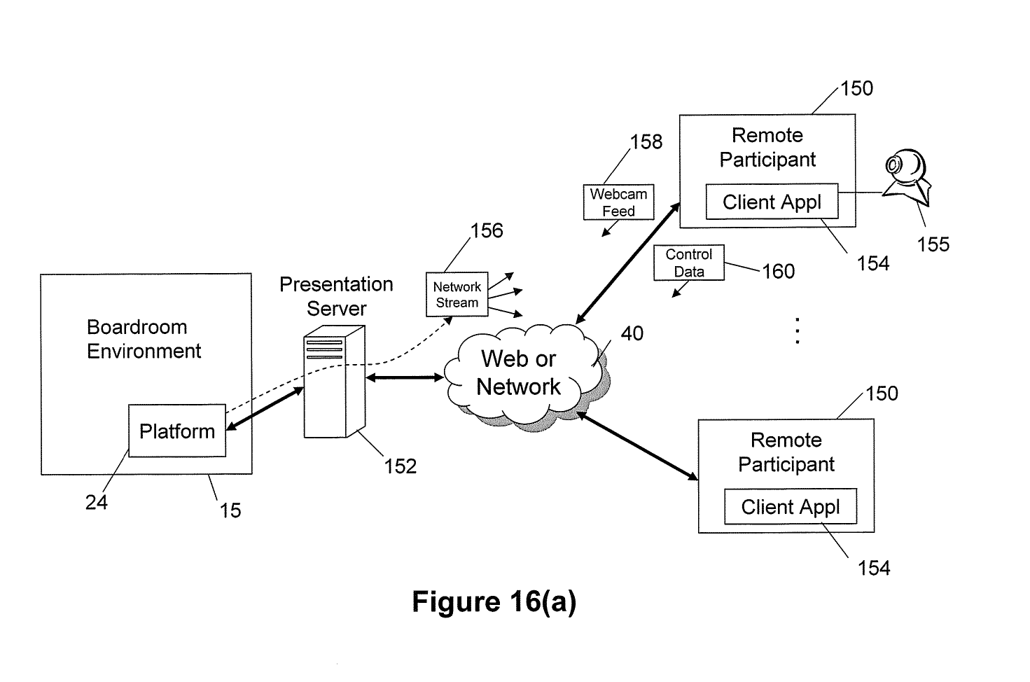

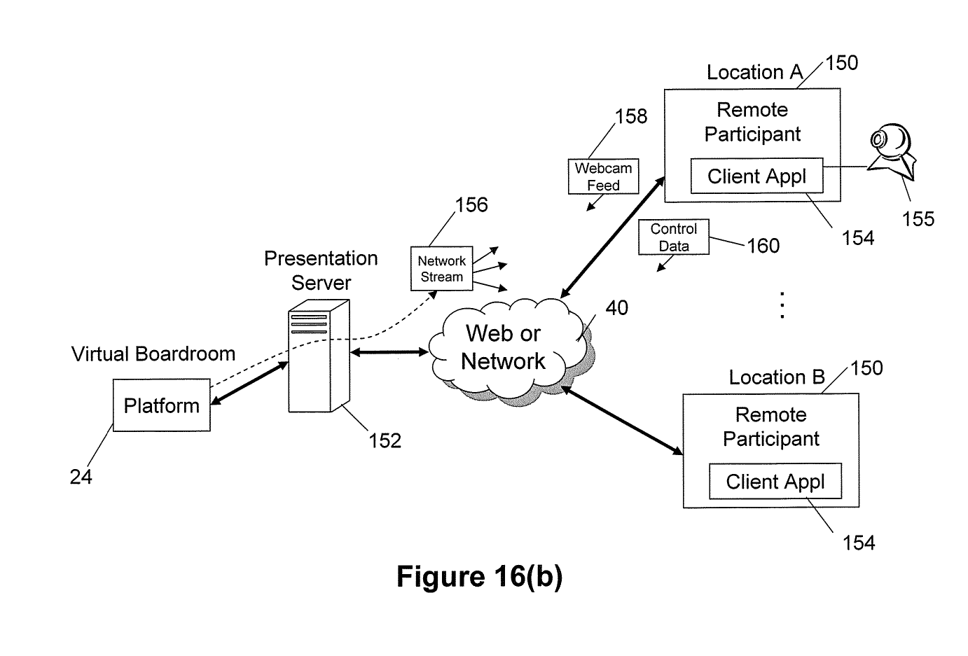

Although the above examples are given in the context of a boardroom environment 15 (e.g. as shown in FIG. 2), it can be appreciated that a platform 24 comprising a smart projection module 12 can also be used in a networked environment as shown in FIGS. 16(a) and 16(b) to enable remote participants 150 to view and/or participate in a presentation from a remote location. As discussed above in connection with FIG. 2, the platform 24 is configured to enable network (e.g. Internet) connectivity in order for a separate computer station 38 to communicate with the smart projection module 12, e.g. to control settings, etc. The following examples extend such connectivity to incorporate remote participants 150.

Turning first to FIG. 16(a), an example configuration is shown to enable remote participants 150 to run a local presentation client application 154 that can communicate with the platform 24 via the network 40 and a presentation server 152. The platform 24 is capable of streaming the presentation as discussed above and in this example sends network streaming data 156 to the remote participant 150. The remote participant 150 can use the client application 154 to view the presentation using the network streaming data 156 and can use its own local webcam 155 or other peripherals to participate in the presentation. For example, the remote participant 150 can use the webcam 155 to stream a live webcam feed 158 back to the platform 24 for incorporation into a presentation being made in a live, physical boardroom environment 15 as shown in the example in FIG. 16(a). In addition to participating, the remote participant 150 can control the presentation by harnessing the connectivity to send control data 160 (e.g. configuration settings, controller keypad commands, etc.). FIG. 16(a) also illustrates that other remote participants 150 can use the client application 154 to simply tune into the presentation and need not participate. The presentation server 152 shown in FIG. 16(a) is only one example component that can be used to extend the boardroom environment 15 to remote locations. In other embodiments (not shown), the platform 24 can be configured to connect directly to the network 40 (e.g. if network 40 is an enterprise configuration or if a server 152 is not required).

The ability of the platform 24 to connect to remote participants 150 via the server 152 and network 40 also enables the platform 24 to host virtual presentations without a physical boardroom environment 15 as shown in FIG. 16(b). It can be appreciated from FIG. 16(b) that the remote participants 150 can connect to the platform 24 in a manner similar to the configuration shown in FIG. 16(a) but in this example each remote participant 150 is connecting from a different location. It can be appreciated that in the configuration shown in FIG. 16(b) at least one of the remote participants 150 would use the client application 154 to control the presentation and to contribute content. However, in other embodiments (not shown), the presentation can be broadcast from a pre-recorded presentation file 23 that is configured to play the presentation without requiring real-time participation (i.e. a virtual host or meeting organizer).

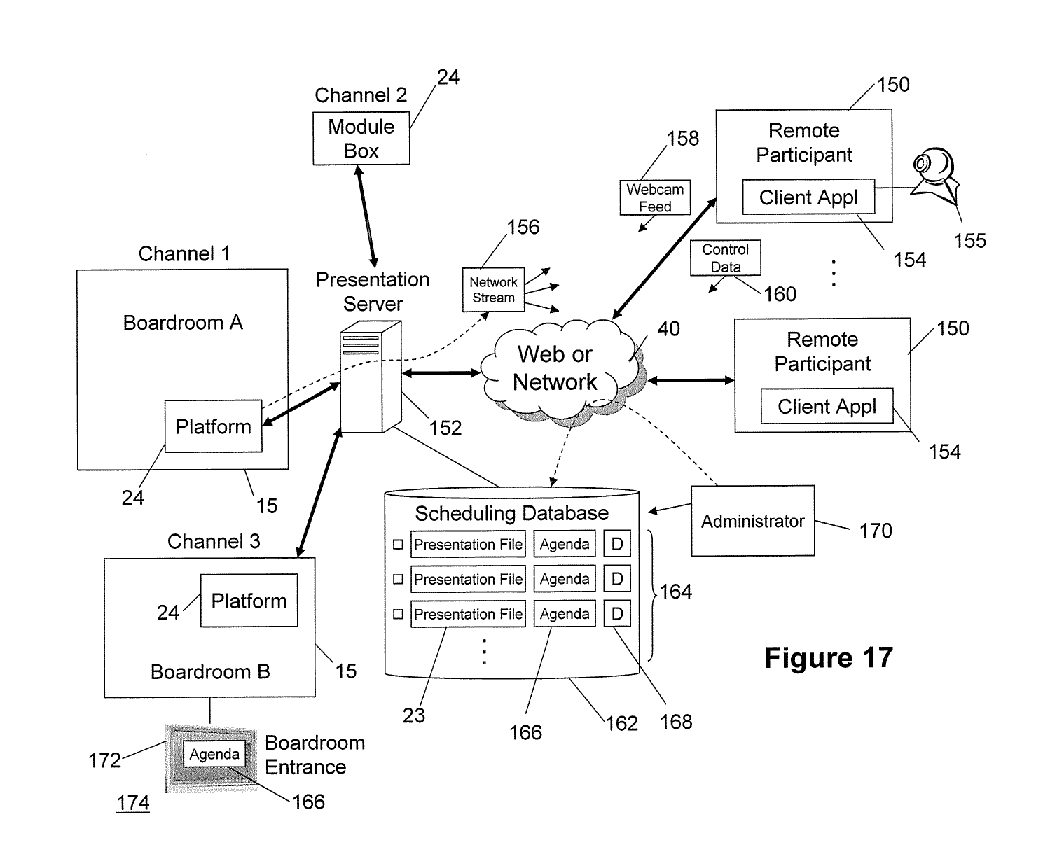

In addition to enabling multiple remote participants 150 to connect to a particular boardroom environment 15 as shown in FIGS. 16(a) and 16(b), turning now to FIG. 17, the presentation server 152 can also be configured to provide multiple presentation channels. In the example shown in FIG. 17, Channel 1 corresponds to a first boardroom, Boardroom A, Channel 2 corresponds to a virtual boardroom, and Channel 3 corresponds to a second boardroom, Boardroom B. It can be appreciated from the configuration shown in FIG. 17 that the remote participants 150 can participate in the same manner as discussed above. To facilitate multiple presentations over multiple channels, a scheduling database 162 is provided. The scheduling database 162 in this example is used to provide a means to “tune in” to the various presentations remotely. The scheduling database 162 comprises one or more presentation entries 164, which comprises the presentation file 23, an associated agenda 166, and other data 168 (e.g. presentation archives, configuration settings, administrative permissions, etc.). An administrator 170 may then use the scheduling database 162 to control which presentation files 23 are to be presented in which boardroom environment 15 or virtual environment and a what time. In this way, central scheduling of the channels can be performed. The presentation files 23 can be loaded into the scheduling database 162 along with the agenda 166 and other data 168 and these items provided to the appropriate channel at the appropriate time. The agenda 166 can also be provided to the boardroom environment 15 for displaying on an agenda board 172 (e.g. a television screen or computer monitor) outside of the boardroom itself.

It can be appreciated that the scheduling database 162 in other embodiments can be configured to only be responsible for enabling remote participants to “tune in” with the loading and playing of presentation files 23 the responsibility of the respective boardroom environment 15. As such, it can be seen that the platform 24 and its connectivity to the server 152 and network 40 enable numerous configurations and possibilities to suit many applications.

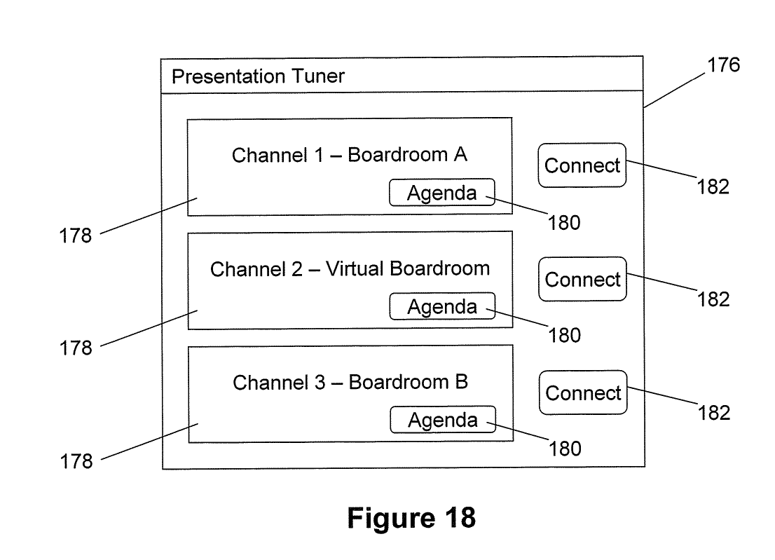

FIG. 18 illustrates an example screen shot of a presentation tuner interface 176 that may be accessed by a remote participant 150 to connect to a selected boardroom. In this example, channel details 178 are provided along with an agenda option 180 to enable the user to view the agenda details or other data pertaining to the presentation being made in that particular boardroom. A connect button 182 may then be selected to join the presentation. It can be appreciated that other interfaces (not shown) may also be provided to enable the user to join as an active participant (e.g. by using webcam 155).

The system configuration shown in FIG. 17 also enables meetings and presentations to be scheduled through email or calendar applications such as those provided by Microsoft Outlook. In this way, a user can schedule a meeting in Outlook, attach the presentation (e.g. PPT) file 23, and the scheduling database 162 (or other program—not shown) can be configured to automatically load the file 23 or send the file to the platform 24 for the presentation. Details of the presentation as added through Outlook (or other scheduling application) can also be automatically added to the schedule screen 172 outside the meeting room 174 that shows the schedule of meetings in the boardroom environment 15

It will be appreciated that any module or component exemplified herein that executes instructions may include or otherwise have access to non-transitory computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the smart projection module 12, platform 24, presentation computer 14, remote participant 150, etc., or accessible or connectable thereto. Any application or module herein described may be implemented using computer readable/executable instructions that may be stored or otherwise held by such computer readable media.

Although the invention has been described with reference to certain specific embodiments, various modifications thereof will be apparent to those skilled in the art without departing from the spirit and scope of the invention as outlined in the claims appended hereto.

1. A method for generating presentations, the method comprising:
obtaining presentation data to be displayed, the presentation data capable of being output using an existing presentation application;
obtaining one or more additional inputs comprising content to be displayed with the presentation data;
rendering a presentation output using the presentation data and the additional inputs according to a template configuration;
enabling control of the presentation output; and
providing the presentation output for projecting onto a display.

2. The method according to claim 1, further comprising providing a keypad for controlling the presentation output, wherein the keypad comprises one or more pre-programmed functions.

3. The method according to claim 1, wherein the one or more additional inputs comprises audio input, visual input, or both, wherein the presentation output organizes the presentation data amongst the additional inputs.

4. The method according to claim 1, further comprising generating a streaming output for providing the presentation output.

5. The method according to claim 4, further comprising receiving a portion of the additional inputs from one or more remote participants.

6. The method according to claim 5, wherein the portion of the additional inputs comprises a video feed from the remote participant to enable the remote participant to participate in the presentation.

7. The method according to claim 4, further comprising enabling one or more remote participants to receive the streaming output to time into the presentation.

8. The method according to claim 7, further comprising providing a plurality of channels, each channel for providing a respective presentation output for a corresponding presentation.

9. The method according to claim 8, further comprising providing a scheduling database for controlling presentations to be provided on the plurality of channels.

10. The method according to claim 1, further comprising archiving the presentation output for later use.

11. A computer readable medium comprising computer executable instruction for:
obtaining presentation data to be displayed, the presentation data capable of being output using an existing presentation application;
obtaining one or more additional inputs comprising content to be displayed with the presentation data;
rendering a presentation output using the presentation data and the additional inputs according to a template configuration;
enabling control of the presentation output; and
providing the presentation output for projecting onto a display.

12. A device for generating presentations, the device being configured for:
obtaining presentation data to be displayed, the presentation data capable of being output using an existing presentation application;
obtaining one or more additional inputs comprising content to be displayed with the presentation data;
rendering a presentation output using the presentation data and the additional inputs according to a template configuration;
enabling control of the presentation output; and
providing the presentation output for projecting onto a display.

13. The device according to claim 12, further comprising a keypad for controlling the presentation output, wherein the keypad comprises one or more pre-programmed functions.

14. The device according to claim 12, wherein the one or more additional inputs comprises audio input, visual input, or both, wherein the presentation output organizes the presentation data amongst the additional inputs.

15. The device according to claim 12, further configured for generating a streaming output for providing the presentation output.

16. The device according to claim 15, further configured for receiving a portion of the additional inputs from one or more remote participants.

17. The device according to claim 16, wherein the portion of the additional inputs comprises a video feed from the remote participant to enable the remote participant to participate in the presentation.

18. The device according to claim 15, further comprising enabling one or more remote participants to receive the streaming output to tune into the presentation.

19. The device according to claim 12, further configured for archiving the presentation output for later use.
